(19) United States
(12) Patent Application Publication
(10) Pub. No.: US 2025/0092547 A1
(43) Pub. Date: Mar. 20, 2025

(54) COPPER CATALYSTS FOR THE ELECTROCHEMICAL CONVERSION OF CARBON DIOXIDE OR CARBON MONOXIDE TO C2+ PRODUCTS

(71) Applicant: JOHNSON MATTHEY PUBLIC LIMITED COMPANY, London (GB)

(72) Inventors: Moyahabo Hellen CHUMA, Pretoria (ZA); Peter Richard ELLIS, Reading Berkshire (GB); Glenn JONES, Reading Berkshire (GB); Luke LUISMAN, Reading Berkshire (GB); Harry Iain Robert MACPHERSON, Reading Berkshire (GB); Iain MALONE, Royston Hertfordshire (GB); Chris ZALITIS, Reading Berkshire (GB)

(21) Appl. No.: 18/727,172

(22) PCT Filed: Feb. 21, 2023
(86) PCT No.: PCT/GB2023/050388

§ 371 Date: Jul. 8, 2024

(30) Foreign Application Priority Data
Feb. 21, 2022 (GB) 2202262.8

(51) Int. Cl. C25B 11/091; C25B 3/03; C25B 3/25; C25B 3/26; C25B 11/032; C25B 11/052

(52) U.S. Cl. CPC C25B 11/091; C25B 3/03; C25B 3/25; C25B 3/26; C25B 11/032; C25B 11/052

(57) ABSTRACT

A catalyst for the electrochemical conversion of carbon dioxide or carbon monoxide to a C2+ product. The catalyst comprises copper and a metal (M) selected from the group consisting of: yttrium (Y), zinc (Zn), lanthanum (La) and gadolinium (Gd); wherein the molar ratio of Cu:M is from 100:1 to 100:10. The catalyst has particular use in a gas diffusion electrode, a catalyst coated membrane of an electrolyser.

### FIELD OF THE INVENTION

The present invention relates to copper catalysts for the electrochemical conversion of carbon dioxide or carbon monoxide to C2+ products such as ethylene.

### DECLARATION OF FUNDING

The project leading to this application has received funding from the European Union's Horizon 2020 research and innovation programme under grant agreement No 761093.

### BACKGROUND

Energy storage is one of the greatest hurdles for the complete adoption of renewable electricity. One approach to sustainable fuels is to convert CO₂ directly into C2+ products such as ethylene which in turn can be converted into fuels e.g. by thermocatalytic reactions. This approach is complementary to established methods producing fuels from synthesis gas (e.g. Fisher Tropsch synthesis) and may involve fewer process steps.

Direct CO₂ conversion may be carried out in an electrochemical reactor called an electrolyser which uses electricity to drive chemical reactions by supplying electrons to the substrate directly, avoiding the need for oxidising or reducing agents. An electrolyser could use surplus electricity from intermittent renewable sources to convert CO₂ into fuels and chemicals, thereby storing the renewable energy as chemical energy in fuel or chemical molecules. A simplified equation for the half reactions occurring in direct CO₂ to ethylene is shown below:

$$Cathode reaction : 2 {CO}_{2} + 8 {H}_{2} O + 12 {e}^{-} \to {C}_{2} {H}_{4} + 12 {OH}^{-}$$

$$Anode reaction : 12 {OH}^{-} \to 6 {H}_{2} O + 3 {O}_{2} + 12 {e}^{-}$$

$$Overall : 2 {H}_{2} O + 2 {CO}_{2} \to {C}_{2} {H}_{4} + 3 {O}_{2}$$

A reaction which competes with the desired C2+ generation reaction is the hydrogen evolution reaction (HER):

$$Hydrogen evolution reaction : 2 {H}_{2} O + 2 {e}^{-} \to {H}_{2} + {OH}^{-}$$

The cathode reaction is sometimes called the CO₂ reduction reaction (CO2RR). Ideally a CO₂RR catalyst needs to satisfy one or more of the following: (1) have a high selectively for the desired fuel or chemical (sometimes measured as Faradic efficiency (“FE”); (2) have low background activity for the competing hydrogen evolution reaction.

A variety of metals can be used as the CO₂RR catalyst and the subject has been recently reviewed in the paper “A Comparison of Different Approaches to the Conversion of Carbon Dioxide into Useful Products: Part I” (Johnson Matthey Technol. Rev. 2021, 65, (2), 180-196).

It is known that the choice of metal catalyst influences the mechanism of CO₂ reduction and therefore the product(s) formed. Copper is an interesting metal for CO2RR because it offers a good balance between overpotential and strength of CO adsorption. Essentially, it allows the intermediate CO formed during the CO2RR to remain loosely adsorbed and mobile, meaning it is able to undergo C—C coupling reactions.

The article “Highly selective plasma-activated copper catalysts for carbon dioxide reduction to ethylene” (Nature Communications 7, 12123 (2016)) describes the preparation of plasma-activated Cu by treating polycrystalline Cu foils with 02 and H2 plasmas of varying power and duration.

The article “Subsurface Oxygen in Oxide-Derived Copper Electrocatalysts for Carbon Dioxide Reduction” (J. Phys. Chem. Lett. 2017, 8, 285-290) describes the treatment of a polycrystalline copper foil to electrochemical oxidation-reduction cycles which increased the overall CO2RR activity of the catalyst and improved the product yield toward more ethylene versus methane.

Oxide-derived copper catalysts have been shown to demonstrate higher activity and selectivity towards C2+ compounds compared to Cu metal. However, copper oxides are easily reduced to copper metal under the highly reducing conditions of CO₂ reduction. To this end, efforts have been made to provide modified catalysts in which the copper is stabilised in a positive oxidation state by incorporating other metals into the structure. These are sometimes referred to as Cud materials. A doped or alloyed material has two advantages: first, the catalytic properties of another element may be utilised in conjunction with Cu and second, the doped material may have unique properties distinct from the elements of this it is composed.

The article “Turning the Selectivity of Carbon Dioxide Electroreduction toward Ethanol on Oxide-Derived CuₓZn Catalysts” ACS Catal. 2016, 6, 8239-8247 describes an improvement in the FE towards C_{n≥2} products (C2+ products) by introducing Zn into the structure. Catalysts with stoichiometry Cu₁₀Zn, Cu₄Zn and Cu₂Zn were prepared from the corresponding bimetallic CuₓZn oxides which were prepared by electrodeposition. These catalysts preferentially produced ethanol instead of ethylene.

There is a need for alternative copper-based electrocatalysts which can convert CO₂ into C2+ products with high selectivity and which are simple to manufacture. The present invention addresses this need.

### DESCRIPTION OF THE FIGURES

FIGS. 1a, 1b and 1c show possible arrangements for an electrolyser according to the invention; and

FIGS. 2 and 3 show charts of Faradaic Efficiency of each reaction product for each catalyst E4 to E7.

### SUMMARY OF INVENTION

It is known that during the initial operation of an electrolyser the pre-catalyst is converted into a reduced catalyst, i.e. by conversion of Cu(II) or Cu(I) into Cu(0). The present inventors have now found that modifying the copper oxide pre-catalyst by including certain metals (M) improves the conversion efficiency of CO₂ to ethylene. The following theory, which has been constructed in hindsight, explains why doping copper oxide with these particular metals improve the selectivity of the reduced catalyst towards ethylene formation.

A key step in the conversion of CO₂ to ethylene is the coordination of —CO onto the catalyst surface followed by dimerization. A catalyst which is selective for ethylene production should therefore have the ability to bind CO, but not so strongly as to prevent dimerization. The standard reduction potentials of various metals M are reported in Table 1. These metals each have a standard reduction potential which is more negative than that of Cu(II) and as a result it is thought that some or all of the modifying metal M remains in a positive oxidation state even after the majority of copper has been reduced to Cu(0).

TABLE 1

| | Standard reduction potential (V) vs SHE |
|---|---|
| Metal (M) | for the reaction Mⁿ⁺ + n e⁻ → M⁰ |
| Y | −2.372 |
| La | −2.38 |
| Gd | −2.279 |
| Zn | −0.7618 |
| Ga | −0.53 |

While each of these metals has a lower standard reduction potential than Cu (Cu²⁺+2 e⁻→Cu⁰+0.337 V), not all metals having a lower standard reduction potential than Cu are effective. For instance, Ga also has a lower standard reduction potential than Cu, but was not able to be co-precipitated with the CuO, as is explained in more detail in the examples.

The presence of specific M ion modifiers within the Cu(0) provides a catalyst which binds CO more strongly than does Cu(0) alone, but not too strongly to prevent dimerization. It is not yet known whether the M ion coordinates CO directly, or whether CO is coordinated by Cu(I) which is stabilised in the modified catalyst, for example by the formation of a CuMO₂ delaffosite phase.

In a first aspect the invention provides a catalyst for the electrochemical conversion of carbon dioxide or carbon monoxide to a C2+ product, wherein the catalyst comprises copper and a metal (M) selected from the group consisting of: yttrium (Y), zinc (Zn), lanthanum (La) and gadolinium (Gd); wherein the molar ratio of Cu:M is from 100:1 to 100:10.

As used herein, unless context requires otherwise, the term “catalyst” can refer to a pre-catalyst containing Cu(II) and M ions, or may refer to the reduced catalyst produced following reduction of the Cu(II) to Cu(I) and/or Cu(0). The Cu:M ratio is not changed when converting the pre-catalyst into the reduced catalyst, although it is expected that the distribution of Cu and M within the catalyst may differ.

As used herein, the term “modified” simply means that the catalyst contains M in addition to Cu. The term “modified” is not intended to imply anything about the distribution of M throughout the copper oxide (pre-catalyst) or copper (reduced catalyst).

In a second aspect the invention relates to the use of a catalyst according to the first aspect of the invention for the electrochemical conversion of CO₂ to C2+ products.

In a third aspect the invention relates to a method of manufacturing a pre-catalyst, comprising the steps of:
(i) providing an aqueous solution comprising a copper (II) salt and a metal M salt;
(ii) optionally heating the solution from step (i) to a temperature of 60-80° C.;
(iii) adjusting the pH of the solution formed in (ii) to a pH of between 6.5 and 10.5 to effect a precipitation reaction and form a precipitate;
(iv) isolating the precipitate;
(v) drying the precipitate to provide the pre-catalyst;
   wherein M is selected from the group consisting of yttrium (Y), zinc (Zn), lanthanum (La) and gadolinium (Gd); and
   wherein the molar ratio of Cu:M in the pre-catalyst is from 100:1 to 100:10.

As used herein, the term “C2+ products” means a product comprising at least two carbon atoms. The catalysts are particularly suitable for the conversion of CO₂ to ethylene.

In a fourth aspect the invention relates to an ink comprising a pre-catalyst dispersed in a polymer.

In a fifth aspect the invention relates to a gas diffusion electrode comprising a gas diffusion layer and a catalyst layer on the gas diffusion layer, wherein the catalyst layer comprises a catalyst as defined in the first aspect.

In a sixth aspect the invention relates to a catalyst coated membrane comprising a membrane having an anode side and a cathode side, wherein a catalyst as defined herein is present at the cathode side.

In a seventh aspect the invention relates to a CO₂ electrolyser comprising a gas diffusion electrode according to the fifth aspect or a catalyst coated membrane according to the sixth aspect.

In an eighth aspect the invention relates to a method for converting CO₂ into C2+ products, comprising the step of providing a feed stream comprising CO₂ to the cathode of a CO₂ electrolyser according to the seventh aspect.

### DETAILED DESCRIPTION

Any sub-headings are included for convenience only, and are not to be construed as limiting the disclosure in any way.

### Catalyst

The catalyst comprises copper and a metal (M) selected from the group consisting of yttrium (Y), zinc (Zn), lanthanum (La) and gadolinium (Gd).

The catalyst produced by the method of the invention is referred to herein as a pre-catalyst and comprises a mixture of copper (II) oxide and M oxide.

The pre-catalyst is converted by reduction to a reduced catalyst (e.g. during initial operation of the electrolyser) in which the majority of the copper (II) oxide is converted to copper (0). By majority, we mean that >50 at % of the copper is present as copper (0), typically >80 at %, such as >90 at %. It is thought that some or all of the metal M remains in a positive oxidation state under these conditions.

The following preferred embodiments apply to both the pre-catalyst and the reduced catalyst.

The molar ratio of Cu:M is from 100:1 to 100:10 (i.e. 1 to 10 atom % M relative to Cu). The preferred ratio of Cu:M differs depending on the choice of M. A typical range is 100:2 to 100:8, such as 100:3 to 100:7, with 100:5 being typical.

In a preferred embodiment M is Y. In another preferred embodiment M is La. In another preferred embodiment M is Gd.

It is preferred that the content of metals other than Cu and M is ≤5 at. %, preferably ≤2 at. % or ≤1 at. %. As an example, a catalyst containing the metals Cu, La and Ba at a molar ratio of 94:5:1 has a content of metals other than Cu and M of 1 at. %.

### Manufacture of the Catalyst

The pre-catalysts described herein can be produced by a simple co-precipitation procedure comprising the steps of:
(i) providing an aqueous solution comprising a copper (II) salt and a M salt;
(ii) optionally heating the solution from step (i) to a temperature of 60-80° C.;
(iii) adjusting the pH of the solution to a pH of between 6.5 and 10.5 to effect a precipitation reaction and form a precipitate;
(iv) isolating the precipitate; and
(v) drying the precipitate;
   wherein M is selected from the group consisting of yttrium (Y), zinc (Zn), lanthanum (La) and gadolinium (Gd); and
   wherein the molar ratio of Cu:M in the pre-catalyst is from 100:1 to 100:10.

It is preferred that in step (i) the only metal salts present are the copper (II) salt and the M salt. It is preferred that the counter anion of the copper (II) salt and M salt is the same. Nitrate salts are particularly suitable.

Step (ii) is an optional step. Heating an aqueous solution containing copper (II) above 60° C. will precipitate copper oxide. Regardless of whether step (ii) is carried out, the pH swing specified in step (iii) is carried out.

In step (iii) the pH is raised to effect a precipitation reaction. Any suitable base may be used, such as amines, alkali metal hydroxides or alkali metal carbonates e.g. NaOH or Na₂CO₃. The pH aimed for in this step will differ depending on the choice of metal M. A typical range is 8.5 to 9.5.

In step (iv) the precipitate is isolated. Suitable techniques will be known to the skilled person, such as vacuum filtration.

It is preferred that between step (iv) and step (v) a washing step (iv-b) is carried out on the precipitate. The role of the washing step is to remove any entrained ions (e.g. Na⁺, NO₃⁻). It is preferred that the material is washed with deionised water until the conductivity of the filtrate is <20 μS.

In step (v) the precipitate is dried to remove excess water. Typical drying conditions are a temperature around 105° C. in air overnight. It will be appreciated that drying conditions may differ depending on scale.

Typically step (v) is followed by a calcination step (vi). The role of step (vi) is to convert any residual metal hydroxide to the corresponding oxide. Typically calcination is carried out at 350° C. for 2 hours, but this may vary depending on the scale of material used.

### Ink

The pre-catalyst may be formulated as an ink for application to a substrate. The substrate may be any substrate on which it is desirable to carry out CO₂ electrolysis. Preferred substrates include: an ion exchange membrane (e.g. an ion exchange membrane such as Nafion™, FumaSep, Pemion™, Aemion™, Sustainion™) or a gas diffusion layer (e.g. Freudenberg or Sigracet carbon paper or a porous PTFE sheet).

The ink comprises a polymer and a pre-catalyst (as defined above) dispersed in the polymer. Suitable polymers will be known to those skilled in the art, and exemplary polymer is Nafion™.

### Coated Substrates

The person skilled in the art will be familiar with the design of a CO₂ electrolyser. A typical CO₂ electrolyser includes a gas diffusion electrode (GDE) and/or a catalyst coated membrane (CCM). Various arrangements of catalyst coated membranes are possible, all of which may benefit from using the catalysts defined herein on the cathode side.

In one aspect the invention relates to a catalyst coated membrane comprising a membrane having an anode side and a cathode side, wherein a pre-catalyst or a reduced catalyst as defined herein is present at the cathode side. As used herein, the term “catalyst coated membrane” refers to a membrane in which at least one of the faces of the membrane is coated with a catalyst. The term “anode side” refers to the side at which the anode reaction (e.g. OER) occurs. The term “cathode side” refers to the side at which the CO₂RR occurs. Various arrangements are possible, and for the avoidance of doubt it is not required that both the anode and/or cathode are applied on the membrane; there may be a gap between the membrane and the anode, or between the membrane and the cathode.

In one embodiment the CCM is coated on the cathode side face with a cathode catalyst (cathode catalyst layer).

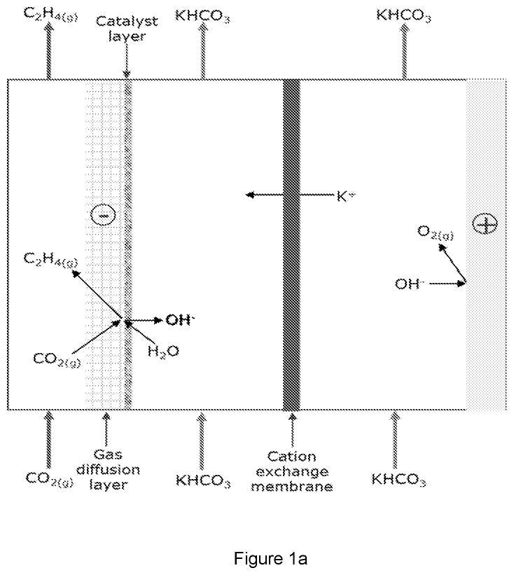

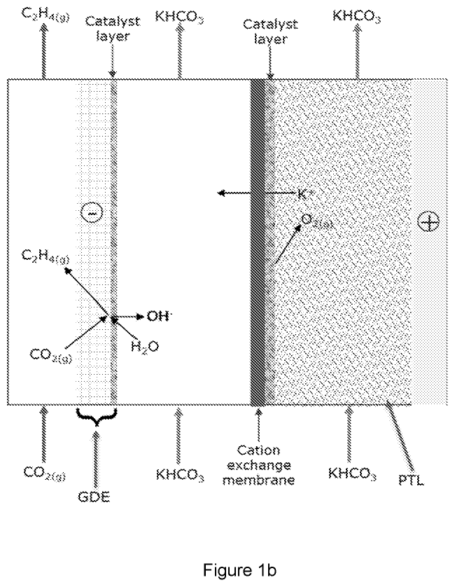

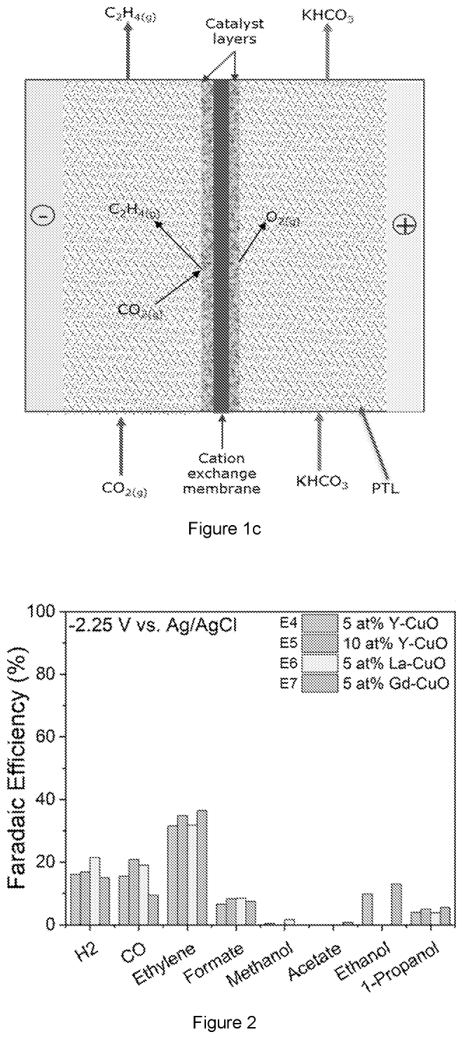

In one embodiment the CCM is coated on the anode side face with an anode catalyst (anode catalyst layer) and a gas diffusion electrode according to the sixth aspect is on the cathode side; this arrangement is shown in FIG. 1b.

In one embodiment the CCM is coated on the cathode side face with a cathode catalyst (cathode catalyst layer) and on the anode side face with an anode catalyst (anode catalyst layer); this arrangement is shown in FIG. 1c.

FIGS. 1a, 1b and 1c illustrate electrolysers containing a cation exchange membrane and using KHCO₃ as the electrolyte. The skilled person will appreciate that other electrolytes may be used and the membrane does not have to be a cation exchange membrane.

The cathode catalyst layer and anode catalyst layer may be applied to the membrane by any techniques known to those skilled in the art, such as by using an ink or a decal.

In one aspect the invention relates to a gas diffusion electrode comprising a gas diffusion layer and a catalyst layer on the gas diffusion layer, wherein the catalyst layer comprises a pre-catalyst or a reduced catalyst as defined herein.

In one embodiment the catalyst layer on the gas diffusion layer comprises a polymer binder.

In one embodiment the gas diffusion electrode comprises a microporous layer on the catalyst layer.

In one aspect the invention relates to an electrolyser comprising a gas diffusion electrode as defined herein or a catalyst coated membrane as defined herein.

In a first embodiment the electrolyser comprises a gas diffusion electrode, an ion exchange membrane and an anode catalyst layer. The gas diffusion electrode includes a catalyst layer comprising pre-catalyst or reduced catalyst as defined herein. The anode catalyst layer is separated from the ion exchange membrane by an electrode gap. An exemplary embodiment is shown in FIG. 1a.

In a second embodiment the electrolyser comprises a CCM which comprises a gas diffusion electrode, an ion exchange membrane and an anode catalyst layer. The gas diffusion layer includes a catalyst layer comprising a pre-catalyst or reduced catalyst as defined herein. The anode catalyst layer is present on one side of the ion exchange membrane. An exemplary embodiment is shown in FIG. 1b, in which a porous transport layer (PTL) contacts the anode catalyst layer.

In a third embodiment the electrolyser comprises a CCM which comprises an ion exchange membrane, an anode catalyst layer and a cathode catalyst layer. The anode catalyst layer is present on one side of the ion exchange membrane and the cathode catalyst layer is present on the other side. The cathode catalyst is pre-catalyst or reduced catalyst as defined herein. An exemplary embodiment is shown in FIG. 1c.

It will be understood that the cathode catalyst may be present on the cathode side (gas diffusion layer on the cathode side or cathode catalyst layer on the ion exchange membrane) either as a pre-catalyst or a reduced catalyst. The pre-catalyst may be reduced to the reduced catalyst before operating the electrolyser for the first time, or may be reduced in situ during start up.

### Use of the Catalyst

The catalyst may be used for the direct electrochemical conversion of CO₂ to C2+ products, such as ethylene. It is known that CO₂ electroreduction involves the conversion of adsorbed CO₂ to adsorbed CO and it is therefore expected that the catalysts could be used for the direct conversion of CO to C2+ products.

### Examples

### General Procedure for the Production of Modified Copper Oxides

Cu(NO₃)₂·2.5H₂O and the respective M (III) nitrate were dissolved in deionised water in the desired Cu:M ratio for the catalyst. The metal concentration (Cu+M) was 15 g/L. The solution was heated to 60° C. with stirring and then 1M NaOH solution was added dropwise until a stable pH of 9 was reached. The temperature was then raised to 70° C. and pH maintained with stirring overnight. The reaction mixture was cooled to room temperature and the solid precipitate was collected by vacuum filtration. The precipitate was washed with deionised water until the filtrate conductivity was <20 μS. The precipitate was dried in vacuum and then dried in air at 105° C. in an oven overnight. The solid was ground and sieved to a powder with particle size <500 μm. The quantities used are shown in Table 1. The same procedure was used to produce an unmodified precipitated CuO.

TABLE 2

| | | metal nitrate | Cu(NO₃)₂•2.5H₂O | |
|---|---|---|---|---|
| Sample | Modifier | (g) | (g) | at % M |
| E1 | Y | Y(NO₃)₃•6H₂O2.98 | 34.1 | 5 |
| E2 | La | La(NO₃)₃•6H₂O3.22 | 32.9 | 5 |
| CE3 | Ga | Ga(NO₃)₃•xH₂O2.00 | 36.1 | 5 |
| E4 | Y | Y(NO₃)₃•6H₂O3.84 | Cu(NO₃)₂•3H₂O45.9 | 5 |
| E5 | Y | Y(NO₃)₃•6H₂O3.84 | 20.9 | 10 |
| E6 | La | La(NO₃)₃•6H₂O2.17 | 22.1 | 5 |
| E7 | Gd | Gd(NO₃)₃•6H₂O6.01 | 103.8 | 5 |

The as-prepared powders of E1, E2 and CE3 were calcined at 350° C. for 2 hours and then were analysed by:

ICP-OES to determine metal ratios and levels of elemental contaminants; and

TEM to determine particle size, shape, dispersion of location of modifiers and Cu within each sample.

The ICP-OES data is reported in Table 3. With the exception of the Ga-modified catalyst (CE3), the amount of modifier measured closely matched that expected (5 at %). It is thought that the low wt % of Ga incorporated into the catalyst is because the conditions of the co-precipitation were not harsh enough for the Ga to be incorporated into the CuO structure.

TABLE 3

| | Modi- | M (wt % | M (at % | Cu (wt % | Fe | Na |
|---|---|---|---|---|---|---|
| Sample | fier | measured) | measured) | measured) | (ppm) | (ppm) |
| E1 | Y | 4.73 | 4.86 | 66.2 | <50 | <50 |
| E2 | La | 7.87 | 5.00 | 68.4 | <50 | <50 |
| CE3 | Ga | 1.64 | 1.92 | 76.5 | <50 | 56 |

TEM analysis of catalysts E1 (Y-modified) and CE3 (Ga-modified) showed an even distribution of Y or Ga throughout the CuO, which is suggestive of a doped structure.

TEM analysis of catalysts E2 (La-modified) showed a segregation of the metals. La formed a fibrous structure separate to the CuO particles.

### General Procedure for Ink Formulation and Gas Diffusion Electrode Fabrication

200 mg of modified copper oxide material (prepared using the method above) was added to a 10 mL glass vial, followed by 333.3 mg of 12 wt % aqueous Nafion™ 1100 EW dispersion (20 wt. % with respect to the modified copper oxide material). 3400 mg of ethanol and 1100 mg of water were added to the vial and the mixture was sonicated for 1 hour to produce the catalyst ink. The ink was then spray coated onto a carbon gas diffusion layer (Freudenberg H23C8) to produce a gas diffusion electrode with a catalyst loading of 1 mg/cm².

### General Procedure for Electrochemical Testing of Modified Copper Oxides

Electrochemical CO₂ reduction was performed using a MicroFlowCell electrochemical reactor (electrolyser) commercially available from ElectroCell Europe A/S, which had an arrangement as shown in FIG. 1a. A gas diffusion electrode (made using the procedure described above) was used on the cathode side of the electrolyser for electrochemical CO₂ reduction. The anode comprised an iridium mixed metal oxide (Ir-MMO) plate (commercially available from ElectroCell Europe A/S). The exposed electrode area was 10 cm² for both the cathode and the anode. Catholyte and anolyte chambers were filled with 120 mL and 500 mL of 1 M KHCO₃, respectively. During electrochemical testing, catholyte and anolyte were flowed through the electrolyser at a flow rate of 50 mL/min and 100 mL/min respectively. The electrolyser was pre-activated by performing cyclic voltammetry (0 V to −0.6 V vs. Ag/AgCl, 20 cycles, scan rate: 50 mV/s) whilst the electrolyser was simultaneously purged with CO₂ at a flow rate of 20 mL/min.

Potentiostatic measurements were then performed at a potential of −2.25 V vs. Ag/AgCl held for 30 minutes. Gaseous products were directly analysed using gas chromatography (GC). Liquid products were collected at the end of each potentiostatic test and analysed using high-performance liquid chromatography (HPLC), equipped with a refractive index detector (RID). The Faradaic Efficiency (FE) for producing the reaction products was determined. Faradaic Efficiency for gaseous products (FE_{gas}) was determined using Equation 1:

$${FE}_{gas} ( \% ) = \frac{n \times C \times {Q}_{flow} \times F}{{V}_{m} \times {j}_{total}} \times 100 \% \qquad Equation 1$$

where C is the concentration of gaseous product as measured by gas chromatography (vol_{product}/Vol_{total product}), n is the number of transferred electrons per mole, F is the Faraday constant (96485 C mol⁻¹), Q_{flow} is the volumetric flow rate (mL min⁻¹), Vₘ is the molar volume of gas (mL mol⁻¹), and jₜₒₜₐₗ is the total current density (A cm⁻²). Faradaic Efficiency for liquid products (FE_{liquid}) was determined using Equation 2:

$${FE}_{liquid} ( \% ) = \frac{m \times n \times F}{{Q}_{total}} \times 100 \% \qquad Equation 2$$

where Qₜₒₜₐₗ is the total charge consumed during the potentiostatic measurement, m is the number of moles of liquid products formed as determined by HPLC analysis, n is the number of transferred electrons per mole, and F is the Faraday constant.

### Results of Electrochemical Testing of Modified Copper Oxides

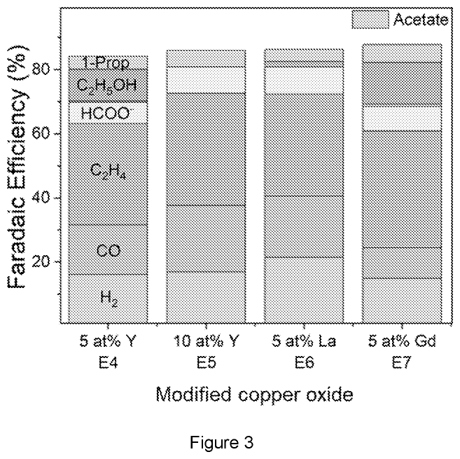

FIGS. 2 and 3 show the Faradaic Efficiency of different reaction products formed during electrochemical CO₂ reduction. Table 4 shows the Faradaic Efficiency for producing H₂, CO and sum total for all C2+ products (i.e. ethylene, ethanol, acetate and 1-propanol).

TABLE 4

| | FE of H₂ | FE of CO | FE of all C2+ |
|---|---|---|---|
| Sample | product (%) | product (%) | products (%) |
| E4 | 16.1 | 15.6 | 45.4 |
| E5 | 16.9 | 20.8 | 39.9 |
| E6 | 21.5 | 19.0 | 35.6 |
| E7 | 14.9 | 9.5 | 55.7 |

Each of the catalysts E4 to E7 are active in the electrochemical conversion of carbon dioxide to C2+ products, such as ethylene, ethanol, acetate and 1-propanol. In particular, al modified copper oxide catalysts E4 to E7 showed highest selectivity towards ethylene production under the conditions tested (as shown in FIGS. 2 and 3).

1. A catalyst for the electrochemical conversion of carbon dioxide or carbon monoxide to a C2+ product, wherein the catalyst comprises copper and a metal (M) selected from the group consisting of: yttrium (Y), zinc (Zn), lanthanum (La) and gadolinium (Gd);
wherein the molar ratio of Cu:M is from 100:1 to 100:10.

2. The catalyst as claimed in claim 1, wherein the catalyst is a pre-catalyst comprising a mixture of copper (II) oxide and M oxide.

3. The pre-catalyst as claimed in claim 2, wherein M is yttrium.

4. The pre-catalyst as claimed in claim 2, wherein M is lanthanum.

5. The pre-catalyst as claimed in claim 2, wherein the molar ratio of Cu:M is from 100:2 to 100:8.

6. The pre-catalyst as claimed in claim 2, wherein the content of metals other than Cu and M in the catalyst is ≤5 at % based on the total amount of metals in the catalyst.

7. The pre-catalyst as claimed in claim 2, wherein the content of metals other than Cu and M in the catalyst is ≤1 at % based on the total amount of metals in the catalyst.

8. The catalyst as claimed in claim 1, wherein the catalyst is a reduced catalyst in which the majority of the copper is present as copper (0).

9. The reduced catalyst as claimed in claim 8 wherein M is yttrium.

10. The reduced catalyst as claimed in claim 8, wherein M is lanthanum.

11. The reduced catalyst as claimed in claim 8, wherein the molar ratio of Cu:M is from 100:2 to 100:8.

12. The reduced catalyst as claimed in claim 8, wherein the content of metals other than Cu and M in the catalyst is ≤5 at % based on the total amount of metals in the catalyst.

13. Use of a catalyst as claimed in claim 1 for the electrochemical conversion of carbon dioxide or carbon monoxide to a C2+ product.

14. A method of manufacturing a pre-catalyst comprising the steps of:
(i) providing an aqueous solution comprising a copper (II) salt and a metal M salt;
(ii) optionally heating the solution from step (i) to a temperature of 60-80° C.;
(iii) adjusting the pH of the solution formed in (ii) to a pH of between 6.5 and 10.5 to effect a precipitation reaction and form a precipitate;
(iv) isolating the precipitate;
(v) drying the precipitate to provide the pre-catalyst;
wherein M is selected from the group consisting of yttrium (Y), zinc (Zn), lanthanum (La) and gadolinium (Gd); and
wherein the molar ratio of Cu:M in the pre-catalyst is from 100:1 to 100:10.

15. The method as claimed in claim 14, wherein the pre-catalyst is comprised of a mixture of copper (II) oxide and M oxide.

16. An ink comprising a polymer and a pre-catalyst dispersed in the polymer, wherein the pre-catalyst is the catalyst as defined in claim 2.

17. A gas diffusion electrode comprising a gas diffusion layer and a catalyst layer on the gas diffusion layer, wherein the catalyst layer comprises the catalyst as defined in claim 1.

18. The gas diffusion electrode according to claim 17, wherein the catalyst layer comprises a polymer binder.

19. The gas diffusion electrode as claimed in claim 17, wherein the gas diffusion electrode comprises a microporous layer on the catalyst layer.

20. A catalyst coated membrane comprising a membrane having an anode side and a cathode side, wherein the catalyst as defined in claim 1 is present at the cathode side.

21. The catalyst coated membrane according to claim 20, comprising a cathode catalyst layer on the cathode side of the membrane, wherein the cathode catalyst layer comprises a catalyst comprising copper and metal (M) selected from the group consisting of: yttrium (Y), zinc (Zn), lanthanum (La), and gadolinium (Gd),
wherein the molar ratio of CU:M is from 100:1 to 100:10.

22. The catalyst coated membrane according to claim 20, comprising a gas diffusion electrode comprising a gas diffusion layer and a catalyst layer on the gas diffusion layer on the cathode side of the membrane, and an anode catalyst layer on the anode side face of the membrane.

23. The catalyst coated membrane according to claim 20, comprising an anode catalyst layer on the anode side of the membrane and a cathode catalyst layer on the cathode side of the membrane, wherein the cathode catalyst layer comprises a catalyst comprising copper and a metal (M) selected from the group consisting of: yttrium (Y), zine (Zn), lanthanum (La) and gadolinium (Gd):
wherein the molar ratio of Cu:M is from 100:1 to 100:10.

24. An electrolyser comprising the gas diffusion electrode according to claim 17.

25. A method for converting CO₂ into C2+ products, comprising the step of providing a feed stream comprising CO₂ to the electrolyser as defined in claim 24.
